(19) United States
(12) Patent Application Publication
(10) Pub. No.: US 2023/0151751 A1
(43) Pub. Date: May 18, 2023

(54) HEATING ELEMENT FOR AN EXHAUST LINE

(71) Applicant: FAURECIA SYSTEMES D'ECHAPPEMENT, Nanterre (FR)

(72) Inventors: ALEXANDRE WESTERMANN, BELFORT (FR); Marion GONZALEZ, MONTBELIARD (FR); Stéphanie MEUNIER, BEAUCOURT (FR)

(21) Appl. No.: 17/987,994

(22) Filed: Nov. 16, 2022

(30) Foreign Application Priority Data
Nov. 17, 2021 (FR) 21 12133

(51) Int. Cl. F01N 3/20; H05B 3/26; B01D 53/94

(52) U.S. Cl. CPC F01N 3/2026; H05B 3/26; B01D 53/94

(57) ABSTRACT

A heating element is provided for an exhaust line, the heating element comprising a substantially tubular housing aligned and/or merging with a pipe of the exhaust line and a heating disc arranged across the housing. The heating disc occupies substantially an entire passage section of the housing and at least two electrodes are electrically connected to the heating disc. The heating disc comprises at least two sectors and a contact member that is arranged between the at least two sectors. The at least two sectors are electrically insulated from each other and electrically connected only by the contact member.

### CROSS-REFERENCE TO RELATED APPLICATION

This application is a U.S. non-provisional application claiming the benefit of French Application No. 21 12133, filed on Nov. 17, 2021, which is incorporated herein by reference in its entirety.

### TECHNICAL FIELD

The disclosure relates to a heating element for an exhaust line.

### BACKGROUND

Such an electrically heated catalyst (EHC) is known to be used to preheat or heat a catalyst to its minimum effective temperature, so that the catalyst can effectively clean the exhaust gases. Such heating is done by radiation and/or convection. The heating element is typically located immediately upstream of the catalyst.

According to a known embodiment, a heating element comprises a housing, substantially tubular, so as to provide a passage section, aligned and arranged in or replacing an exhaust pipe, in which exhaust gases from an internal combustion engine flow. A heating disc is arranged in this housing across the passage section.

The heating disc is perforated and/or porous, to allow the passage of exhaust gases through its section. In addition, it is metallic and electrically resistant. It is connected to at least two electrodes allowing an electric current to flow through it, so as to heat the heating disc by the Joule effect. This heat is transferred to the catalyst, located downstream of the heating disc, by radiation and convection, the heat being carried by the gases, air or exhaust gases, flowing through the heating disc.

In order to obtain electrical paths from one electrode to the other of equal length/resistance, while uniformly covering the entire surface of the heating disc, in order to obtain a substantially uniform temperature, it is known to arrange one electrode in the center of the heating disc and at least one other electrode at the periphery of the heating disc, this periphery being in electrical continuity.

However, a centrally placed electrode creates a significant pressure drop. It is also difficult to install with respect to attaching it to the heating disc. In addition, a central electrode significantly increases the mechanical inertia of the heating disc and thus greatly reduces its service life.

Also, it is sought to find ways of implementation, which do not require a central electrode.

### SUMMARY

The principle of the disclosure is to divide the heating disc into a plurality of sectors, electrically connected to each other only by a point. Thus, it is possible to have only peripheral electrodes.

To this end, the disclosure relates to a heating element for an exhaust line, the heating element comprising a substantially tubular housing aligned and/or merging with a pipe of the exhaust line. A heating disc is disposed across the housing, and occupies substantially the entire passage section of the housing. At least two electrodes are electrically connected to the heating disc. The heating disc comprises at least two sectors and a contact member disposed between said at least two sectors. The at least two sectors are electrically insulated from each other and electrically connected only by the contact member.

Particular features or embodiments, which may be used alone or in combination, are:

the contact member is substantially central, relative to the heating disc,

none of said at least two electrodes are central,

each of said at least two electrodes is peripherally connected to one of said at least two sectors,

a first of said at least two electrodes is peripheral and connected to the end of a first sector and a second of said at least two electrodes is peripheral and connected to the beginning of a second sector, immediately adjacent to the first sector, so that the first and second electrodes are adjacent,

said at least two sectors are two in number,

two adjacent sectors of said at least two sectors are rigidly connected by a rigid stiffener, comprising two parts pressing the edges of the two adjacent sectors between them and made of electrically insulating material,

two adjacent sectors of said at least two sectors are rigidly connected by a spiral binding made of electrically insulating material,

the heating element further comprises at least one wafer-shaped support extending over substantially the entire passage section of the housing, which support is pressed against the heating disc and is fixed to the housing, is made of electrically insulating material or is separated from the heating disc by electrically insulating material, a support preferably having radii and large openings, and preferably at least two supports arranged on both sides of the heating disc.

In a second aspect, a gas purification device for an exhaust line is provided that comprises a purification member and such a heating element arranged in proximity to the purification member.

In a third aspect of the disclosure, an exhaust line comprising at least one such heating element is provided.

### BRIEF DESCRIPTION OF THE DRAWINGS

The disclosure will be better understood upon reading the following description, given only as an example, and with reference to the attached drawings, in which:

FIG. 1 shows a perspective view of a heating element according to the disclosure,

FIG. 2 shows a top view of a heating disc according to the disclosure,

FIG. 3 shows a top view of the heating element of FIG. 1,

FIG. 4 shows a side cut view of one embodiment of a contact member between two sectors,

FIG. 5 shows a side cut view of a further embodiment of a contact member between two sectors, and

FIG. 6 shows a perspective view of an assembly between two sectors.

### DETAILED DESCRIPTION

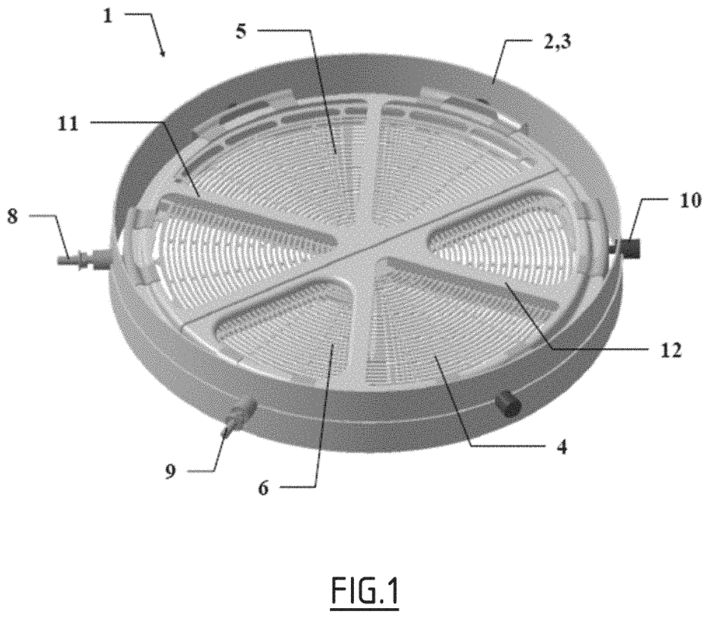

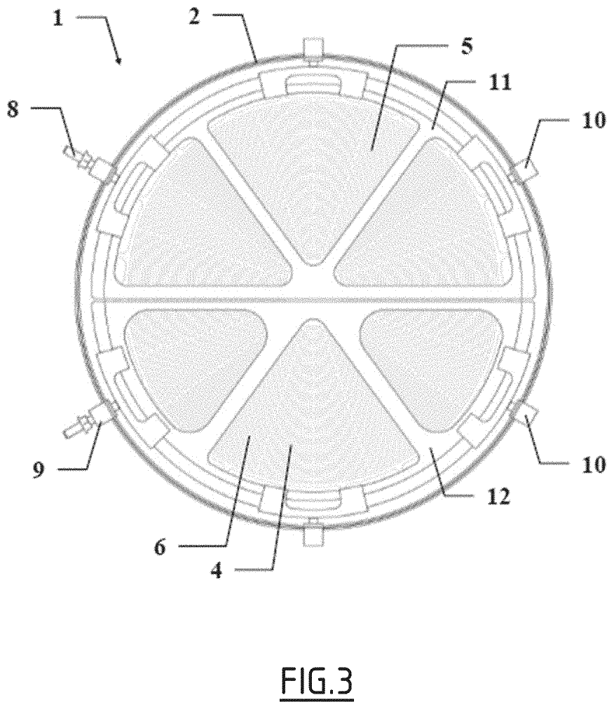

With reference to FIGS. 1 and 3, the disclosure relates to a heating element 1 for an exhaust line. Such a heating element 1 comprises a substantially tubular housing 2. The tubular section can be of any shape. In the illustrated embodiment, this passage section is circular. The housing 2 merges with and aligns with, or even locally replaces, an exhaust pipe 3 of the exhaust line. The exhaust gas flows through the pipe 3 and through the housing 2 in its circulation from the engine to the exhaust pipe. A heating disc 4, in the form of a wafer with an external cross-section substantially the same as the cross-section of the housing 2, is arranged across the passage section of the housing 2, so as to occupy substantially the entire passage section of the housing 2.

In a known way, the heating disc 4 is made, at least in part, of conductive material, preferably metallic, in order to be electrically resistant. The heating disc 4 is connected by at least two electrodes 8, 9 to a power source. Therefore, when current flows through the heating disc 4, it causes heating of the disc by the Joule effect.

In order to obtain a multitude of electrical paths which are substantially identical in terms of length and resistance, a heating disc according to the prior art is classically homogeneous, one electrode is arranged substantially in the center of the heating disc and at least one other electrode is arranged at the periphery, the latter being in electrical continuity, so as to form an equipotential.

One of the objectives of the present disclosure is to avoid the need for a central electrode in order to avoid all the disadvantages associated with such an electrode arrangement.

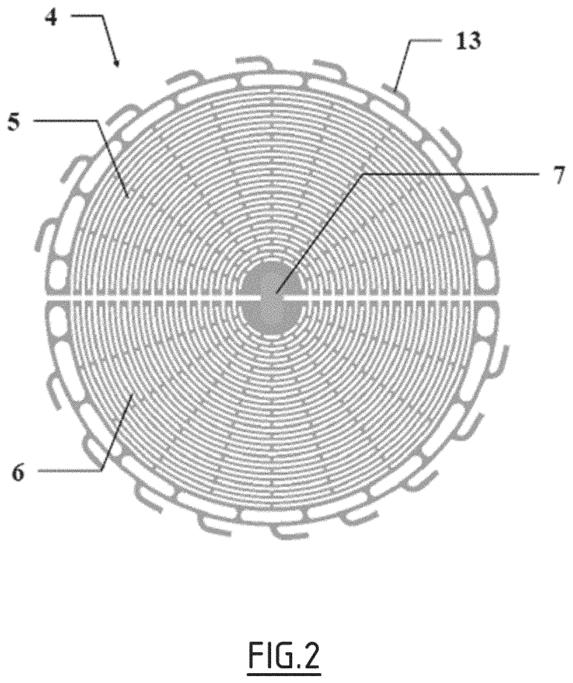

To this end, as illustrated in FIG. 2, showing a heating disc 4 alone, according to one feature, the heating disc 4 of the heating element 1 according to the disclosure comprises at least two sectors 5, 6.

The heating disc 4 is thus divided into at least two sectors 5, 6, preferably cut from the center of the heating disc 4, and even more preferably according to equal angular sectors.

These sectors 5, 6 are separated from each other, at least in such a way that there is no electrical continuity, excluding a contact member 7. This contact member 7 is advantageously substantially point-based. This contact member 7 is arranged between said at least two sectors 5, 6, so as to electrically connect, at a point, said at least two sectors 5, 6. The electrical connection point made by the contact member 7 is the only electrical contact between said at least two sectors 5, 6.

The contact member 7 is typically the area at the geometric center of the heating disc. It is small in size relative to the surface of the disc.

The heating disc 4 is divided into sectors 5, 6 by unreferenced radial slots extending from said central area to the peripheral edge of the disc 4. These slots are open at the said peripheral edge.

Sectors 5, 6 are angular sectors, i.e. areas of the disc delimited between two radial slots.

The radial slots are angularly distributed around the center of the disc. Sectors 5, 6 are therefore of equal size, and cover the same arc around the center of the disc.

The disc is split into at least two sectors, for example three, four or more sectors.

Thus, each sector 5, 6 is electrically independent of the other. The periphery or arc of a sector 5, 6 is always an equipotential. Also, by placing an electrode 8 at any point in the arc of one sector 5, and another electrode 9 at any point in the arc of another sector 6, all electrical paths of lower resistance are substantially radial, from an electrode 8 at the arc of the first sector 5 to the center of the first sector 5, and then from the center of the second sector 6 to the arc of the second sector 6, where the electrode 9 is located.

Thus, the division of the heating disc 4 into sectors 5, 6, electrically connected only via the point-based contact member 7, allows a homogeneous heating of a heating disc 4, with only peripheral electrodes 8, 9.

There should be at least one anode and at least one cathode, among the peripheral electrodes 8, 9. From the third electrode onwards, the latter can be either an anode or a cathode.

The dividing of the heating disc 4 into sectors 5, 6 further reduces the size of the sheets of material constituting the heating disc 4. This becomes appreciable for a heating element intended for a heavy vehicle for which the heating disc 4 has a diameter of between 50 and 500 mm, preferably between 100 and 400 mm, and more preferably between 220 and 340 mm. By dividing the heating disc 4 into two or four sectors 5, 6, the width of a roll of constituent metal foil can be halved, for example from 350 mm to 175 mm.

In a further feature, the contact member 7 is substantially central, relative to the heating disc 4. This feature improves the homogeneity of the electrical paths and the heating.

A heating disc 4, as shown in FIG. 2, occupies substantially the entire passage section of the housing 2. In order to adapt this feature, including to take into account thermal expansion, a heating disc 4 advantageously comprises flexible blades 13 at its periphery.

The main purpose of the disclosure is to remove the central electrode. However, it is quite possible to arrange such a central electrode (not shown). In this case, the central electrode has a polarity opposite to the polarity of the peripheral electrode or all other peripheral electrodes. Thus, if the central electrode is an anode, the peripheral electrode or all peripheral electrodes are cathodes, and vice versa.

If a central electrode is present, it is advantageously connected to the contact member 7.

The main purpose of the disclosure is to remove the central electrode. Also, according to a preferred embodiment, none of said at least two electrodes 8, 9 is central. All electrodes are then peripheral.

According to another feature, each of said at least two electrodes 8, 9 is peripherally connected with one of said at least two sectors 5, 6.

In a dual manner, according to another feature, each of said at least two sectors 5, 6 is peripherally connected to at least one of said at least two electrodes 8, 9.

It is possible to place several electrodes 8, 9, necessarily of the same polarity, on the same sector 5, 6. There is, however, no reason not to connect a sector 5, 6. An unconnected sector 5, 6 does not heat up.

It was seen earlier that the periphery or arc of a sector 5, 6 is an equipotential. Also, according to another feature, an electrode 8, 9 can be connected at any point of an arc of a sector 5, 6. According to an advantageous arrangement, more particularly illustrated in FIGS. 1 and 3, a first of said at least two peripheral electrodes 8 is connected to the end of a first sector 5 and a second of said at least two peripheral electrodes 9 is connected to the beginning of a second sector 6, immediately adjacent to the first sector 5. Such an arrangement advantageously allows the first and second electrodes 8, 9 to be brought closer together until they are adjacent. This feature is advantageous in terms of the integration of the heating element 1 thus created, in that the cables connecting the electrodes 8, 9 are simpler to place outside the heating element 1.

The electrodes 8, 9, whatever their arrangement, are rigidly connected to the heating disc 4, and still provide a function of supporting the heating disc 4 and fixing it to the housing 2. Also, although at least two active electrodes 8, 9 are required for the flow of current for heating, dummy electrodes 10, which are electrically inactive, can be used to support the heating disc 4. This feature is all the more advantageous as the cutting of the heating disc 4 into sectors 5, 6 makes it more deformable and the at least two active electrodes 8, 9 are adjacent.

It was seen that the number of sectors 5, 6 is at least two. The number of sectors 5, 6 can thus be arbitrary. As a minimum, and as illustrated in the various figures, the number of sectors 5, 6 is two.

Compared to a heating disc of the prior art, which can be made from a single piece, the rigidity of a heating disc 4 according to the disclosure is reduced due to the cut(s) between two sectors 5, 6. Also, according to a further characteristic, in order to restore rigidity to the heating disc 4, two adjacent sectors 5, 6 can advantageously be joined together by a binding, by a stiffener 16 or by a spiral binding 14, 15.

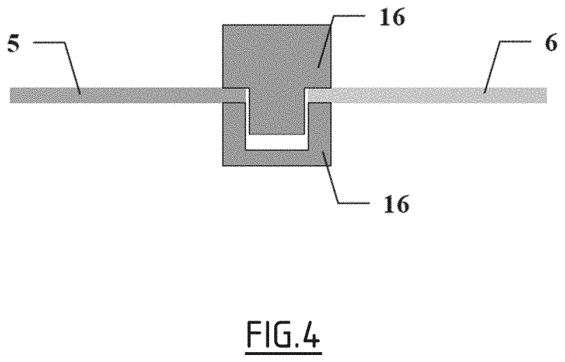

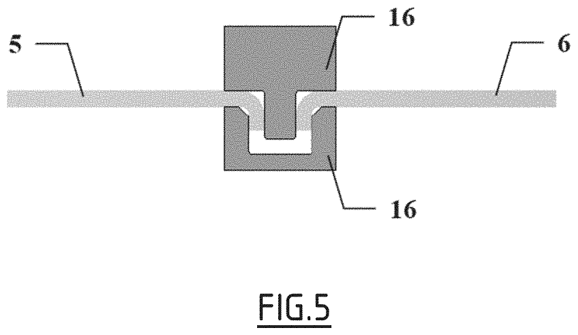

FIGS. 4 and 5 illustrate, in a cutaway profile view, two ways in which a binding with a stiffener 16 can be implemented. According to a first embodiment, illustrated in FIG. 4, the stiffener 16 comprises two parts, substantially rectilinear along a boundary between two adjacent sectors 5, 6, one upper and one lower, capable of engaging each other. As shown in FIG. 4, the two parts, upper and lower, are engaged with each other, clamping the two sectors 5 and 6 between them. The stiffener 16 must not conduct electricity between the two sectors 5, 6. Also, the stiffener 16 is made of an electrically insulating material, is coated with such a material or such a material is inserted between the stiffener 16 and the sectors 5, 6. Thus, the pinching of the stiffener 16 prevents any electrical contact between the sectors 5, 6. In this embodiment, the connection between the two parts of the stiffener 16, upper and lower is maintained, for example, by a tight fit between these two parts.

As shown in FIG. 5, the two upper and lower pieces are engaged with each other, with more clearance than before, so as to pinch the two sectors 5 and 6, as well as to deform their edge so as to insert it between the two stiffener pieces 16. As before, the stiffener 16 is electrically insulating. In this embodiment, the connection between the two parts, upper and lower, is held together by, for example, a tight fit between the two parts of the stiffener 16, including the respective edges between them.

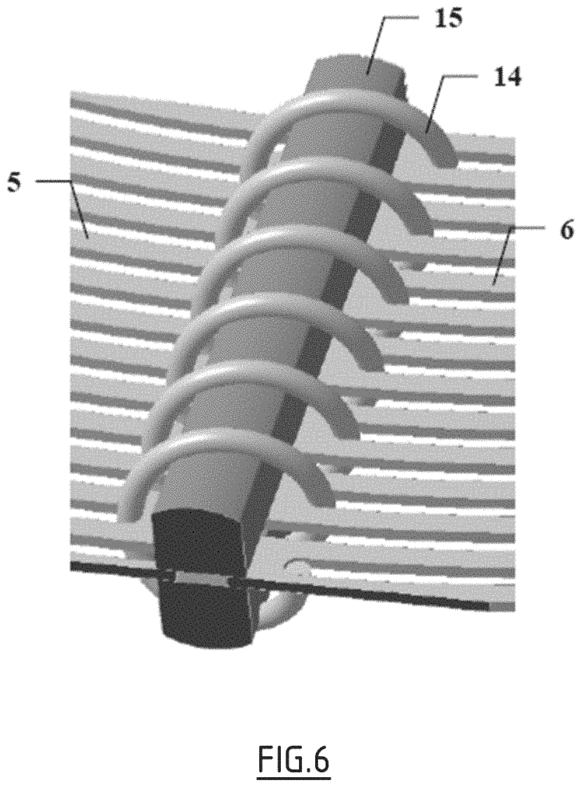

As illustrated in FIG. 6, a spiral binding assembly advantageously comprises two substantially straight bars 15, aligned and straddling the dividing line between the two adjacent sectors 5, 6. These two bars 15 are arranged opposite each other on one side of the two sectors 5, 6. This assembly is further completed by a spiral 14 winding along the dividing line between the two sectors 5, 6, alternately crossing the surface of one sector 5 and then the surface of the other sector 6, so as to knit an assembly. The spiral 14, due to its circular internal shape, complementary to the external profile of the bars 15, ensures that a bar 15 is held against the face opposite the edges of the sectors 5, 6. This makes it possible to form an assembly holding together sectors 5, 6 and tending to stiffen the whole along the same plane.

Both the spiral 14 and the bars 15 are simultaneously in contact with both sectors 5, 6. Also, in order to avoid any short-circuit, it is imperative that the spiral 14 and the bars 15 are both made of an electrically insulating material, at least as regards their parts in contact with the sectors 5, 6.

In order to withstand the temperatures encountered in an exhaust line, which can reach 800° C., both the spiral 14 and the bars 15 are preferably made of metal covered with a varnish or an insulating coating, such as mica or ceramic.

In view of the fragility caused to the heating disc 4 by dividing it into sectors 5, 6, according to another feature, more particularly illustrated in FIGS. 1 and 3, the heating element 1 advantageously still comprises at least one support 11, 12. The at least one such support 11, 12 is in the form of a wafer occupying the entire passage section of the housing 2. It is suitable for pressing against the heating disc 4 and for fixing to the housing 2. It has radii to hold the heating disc 4 in a plane and large openings to minimise pressure drops opposing the exhaust gases. Preferably, such supports 11, 12 are arranged on either side of the heating disc 4.

A support 11, 12 in contact with one or more sectors 5, 6 must not be electrically conductive. Furthermore, a support 11, 12 is made of a non-metallic material such as ceramic, refractory fibre or mica, or of a metallic material coated with an electrically insulating deposit.

The disclosure further relates to a gas purification device for an exhaust line comprising a purification member and such a heating element 1 arranged in proximity to the purification member. The purification member is, for example, a three-way catalyst, a diesel oxidation catalyst, an SCR catalyst or any other suitable type. The heating element 1 is advantageously arranged upstream of the purification member.

The disclosure further relates to an exhaust line comprising at least one such heating element 1.

The disclosure has been illustrated and described in detail in the drawings and the preceding description. This should be considered as illustrative and by way of example and not as limiting the disclosure to this description alone. Numerous other embodiments are possible.

### LIST OF REFERENCE SIGNS

1: heating element,

2: housing,

3: pipe,

4: heating disc,

5, 6: sector,

7: contact member,

8, 9: electrode,

10 dummy electrode,

11, 12: support,

13: blades,

14: spiral,

15: bar,

16: stiffener

1. A heating element for an exhaust line, comprising:
a substantially tubular housing aligned and/or merging with a pipe of the exhaust line;
a heating disc arranged across the substantially tubular housing, occupying substantially an entire passage section of the substantially tubular housing; and
at least two electrodes electrically connected to the heating disc, wherein the heating disc comprises at least two sectors and a contact member arranged between said at least two sectors, said at least two sectors being electrically insulated from each other and electrically connected only by the contact member.

2. The heating element according to the claim 1, wherein the contact member is substantially central, relative to the heating disc.

3. The heating element according to the claim 1, wherein neither of said at least two electrodes is central.

4. The heating element according to the claim 1, wherein each of said at least two electrodes is peripherally connected with one of said at least two sectors.

5. The heating element according the claim 1, wherein a first electrode of said at least two electrodes is peripheral and connected to an end of a first sector and a second electrode of said at least two electrodes is peripheral and connected to a beginning of a second sector, immediately adjacent to the first sector, so that the first and the second electrodes are adjacent.

6. The heating element according to the claim 1, wherein said at least two sectors are two in number.

7. The heating element according to the claim 1, wherein two adjacent sectors of said at least two sectors are rigidly connected by a rigid stiffener, comprising two parts, pressing edges of the two adjacent sectors therebetween and made of electrically insulating material.

8. The heating element according to the claim 1, wherein two adjacent sectors of said at least two sectors are connected by a spiral binding made of electrically insulating material.

9. The heating element according to the claim 1, further comprising at least one wafer-shaped support extending over substantially an entire passage section of the substantially tubular housing, wherein the at least one wafer-shaped support is pressed against the heating disc and is fixed to the substantially tubular housing, and is made of electrically insulating material or is separated from the heating disc by electrically insulating material.

10. The heating element according to the claim 9, wherein the at least one wafer-shaped support has radii and large openings.

11. The heating element according to the claim 9, wherein the heating element comprises at least two wafer-shaped supports arranged on both sides of the heating disc.

12. A gas purification device for an exhaust line comprising a purification member and a heating element arranged in the vicinity of the purification member, wherein the heating element is the heating element according to claim 1.

13. An exhaust line comprising at least one heating element according to claim 1.
